(19) United States
(12) Patent Application Publication
(10) Pub. No.: US 2013/0089724 A1
(43) Pub. Date: Apr. 11, 2013

(54) NOVEL ORGANIC UV ABSORBERS

(71) Applicants: Olivier Poncelet, Grenoble (FR); Olivier Renard, Fontanil-cornillon (FR)

(72) Inventors: Olivier Poncelet, Grenoble (FR); Olivier Renard, Fontanil-cornillon (FR)

(73) Assignee: COMMISSARIAT A L'ENERGIE ATOMIQUE ET AUX ENERGIES ALTERNATIVES, Paris (FR)

(21) Appl. No.: 13/521,658

(22) PCT Filed: Jan. 11, 2011
(86) PCT No.: PCT/IB11/50117

§ 371 Date: Nov. 27, 2012

(30) Foreign Application Priority Data
Jan. 11, 2010 (FR) 1050135

(51) Int. Cl. C09K 3/00

(52) U.S. Cl. CPC C09K 3/00
USPC 428/221; 428/392

(57) ABSTRACT

The invention relates to the use, particularly in an organic or inorganic material, of at least one pyrene derivative represented by the general formula (I), in which n represents an integer between 1 and 4, or one of the salts thereof, as an ultraviolet absorbing agent.

The present invention relates to the use of pyrene derivatives as agents which absorb UV radiation.

The stability of materials exposed to solar irradiation, such as polymers, paints, varnishes or textiles, is a recurrent problem which is treated by the addition to these materials of organic compounds capable of absorbing UV radiation and/or of inorganic compounds capable of screening out high-energy radiation.

A person skilled in the art commonly uses one or other of these UV screening agents or even a mixture of them (organic/inorganic mixtures) according to the level of performance targeted and the use envisaged.

It should be noted that the level of performance is assessed in terms of efficiency of absorption in the UV region but also of durability. This is because, for obvious reasons, it is desirable for the ability of the compound to absorb UV radiation to be exercised in a prolonged manner over time. In other words, such a compound has to have significant stability.

In addition, it must remain inert with regard to the materials with which it is combined. More specifically, the UV absorber has to be stable under UV radiation and must not detrimentally affect the initial properties of the material to be protected (color and appearance, mechanical properties, feel properties, flame retardancy properties, and the like).

Finally, for obvious reasons, it must be easy to employ. In particular, its incorporation in materials must not raise difficulties, for example in terms of dissolution, and/or of dispersion in the colloidal medium.

In point of fact, the currently existing organic and inorganic UV screening agents do not simultaneously satisfy all of these requirements.

As regards the inorganic UV screening agents, such as titanium dioxide (TiO₂), zinc oxide (ZnO) or cerium dioxide (CeO₂), they intrinsically have an advantage in terms of stability as they are oxides. Being already oxidized, they are chemically stable and thus not very susceptible to change. Unfortunately, the energy which is absorbed by these oxide particles is not entirely dissipated in the form of heat. A portion is transferred to the neighboring organic molecules, which are then oxidized. The weak point of the inorganic UV screening agents is thus related to the degradation of the organic compounds which are generally combined with them in the formulations.

At the same time, it should be noted that, due to their high refractive index, the inorganic UV screening agents scatter the light, which brings about an opaque appearance of the coating which is covered with them.

As regards the organic UV absorbers, substituted benzotriazoles and hydroxybenzophenones prove to be very particularly advantageous from the viewpoint of their performances in terms of properties of absorbance and of stability. This is because these organic UV absorbers exhibit mechanisms for the dissipation of the absorbed energy by reversible conformational change which allow them to be described as “regeneratable”.

On the other hand, only a small number of organic absorbers of this type are currently available. Furthermore, their use remains restricted by their low solubility in an aqueous medium.

For obvious reasons, it would be advantageous to overcome these two inadequacies.

The present invention is targeted specifically at meeting this need.

Thus, according to one of its aspects, the subject matter of the present invention is the use, as agent which absorbs ultraviolet radiation, of at least one pyrene derivative represented by the general formula (I):

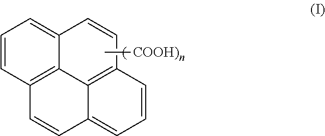

in which n represents an integer from 1 to 4, or one of its salts.

According to a specific form, the invention relates to the use, as agent which absorbs ultraviolet radiation, of at least one compound represented by the formula (I) in which n is less than or equal to 2, or one of its salts.

More particularly, another subject matter of the invention is the use, as agent which absorbs ultraviolet radiation, of the pyrene derivative of formula:

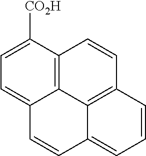 [SMILES: O=C(O)c1ccc2ccc3cccc4ccc1c2c34]

or one of its inorganic salts.

Advantageously, a salt in accordance with the invention is an alkaline salt, preferably a sodium or potassium salt.

The inventors have thus found that the compounds under consideration in the context of the present invention are advantageous in several respects.

They absorb UV radiation and do not absorb above 400 nm and in this respect are thus not capable of affecting the coloring effect of a coloring agent which would be combined with them, which is very important for the majority of the applications envisaged (textile, paper or cosmetic).

The absorption spectra of the pyrene derivatives under consideration according to the invention advantageously exhibit several very strong absorption peaks between 290 nm and 360 nm.

The pyrene derivatives under consideration according to the invention also exhibit advantageous and unexpected stabilities with respect to UV/visible radiation. Thus, they exhibit a better stability toward solar irradiation than conventional UV stabilizers, making it possible to confer better properties of durability on the protected material, for example a coating, such as paints and varnishes, or a textile. This is particularly the case with pyrene-1-carboxylic acid, which shows, in some cases, a stability toward radiation equivalent to that of substituted benzotriazoles.

Furthermore, the compounds under consideration according to the invention prove to exhibit fluorescence properties in the green region in general when they are subjected to UV radiation. Due to the intensity re-emitted, this does not affect the color of the material to be protected. On the other hand, the fluorescence is a means for dissipating the energy absorbed by the UV absorber: this property thus contributes to its stability under UV radiation.

Finally, they have very good solubility in water, which facilitates the use thereof in formulations.

The pyrene derivatives under consideration according to the invention are commercially available or can be easily prepared by a person skilled in the art. They are generally obtained from petroleum naphthas (content at approximately 4% by weight). They are subsequently subjected to stages of nitration and then of functionalization in order to result in the desired derivative.

In particular, the pyrene-1-carboxylic acid employed is that sold by Aldrich.

The derivatives under consideration according to the invention are advantageously employed as UV-absorbing agents in a free form, that is to say in a form not covalently bonded to a supplementary compound.

The invention also relates to an organic or inorganic material comprising, as agent which absorbs ultraviolet radiation, at least one pyrene derivative of formula (I).

The derivative can be employed therein for the purposes of protecting said material when the latter is sensitive to light and/or another component which is also present in said material and which displays a sensitivity to light.

The invention also relates to a process for the stabilization of an organic or inorganic material with regard to UV decomposition, comprising addition, to this material or to a precursor of this material, of at least one pyrene derivative in accordance with the invention as agent which absorbs ultraviolet radiation.

The materials in which the pyrene derivatives under consideration according to the invention can be incorporated can be of varied natures, in particular polymeric or nonpolymeric natures.

In the field of polymer materials, they may in particular be elastomers, adhesives, paints or other types of coatings.

More specifically, the polymers in which the pyrene derivatives used according to the invention can be incorporated are, for example:
polymers of monoolefins and diolefins, for example polypropylene and polyisobutylene, and also polymers of cycloolefins, for example cyclopentene and norbornene,
copolymers of monoolefins and diolefins, for example copolymers of ethylene and propylene, copolymers of alkyl methacrylate and ethylene, copolymers of vinyl acetate and ethylene, copolymers of acrylic acid and ethylene, their blends and their blends with other polymers, such as polyamides,
hydrocarbon resins,
polystyrenes,
styrene copolymers,
halogen-comprising polymers,
polymers derived from α,β-unsaturated acids and their derivatives, such as polyacrylates and polymethacrylates, polyacrylamides and polyacrylonitriles,
copolymers of monomers mentioned above,
polymers derived from unsaturated alcohols and from amides of acyl or acetal derivatives, such as, for example, polyvinyl alcohol,
homopolymers and copolymers of cycloethers, such as polyalkylene glycol,
polyacetals, such as polyoxymethylene,
polyamides and copolyamides derived from diamines and dicarboxylic acids, and/or from aminocarboxylic acids or corresponding lactams,
polyureas, polyimides, polyamide-imides, polyetherimides, polyesterimides, polyhydantoins and polybenzimidazoles,
polyesters derived from dicarboxylic acids and diols and/or derived from hydroxycarboxylic acids or corresponding lactones,
polycarbonates and polyester-carbonates, and
natural polymers, such as cellulose, rubber, gelatin and their chemically modified homologous derivatives, such as cellulose acetates.

The amount of pyrene derivatives according to the invention to be used depends on the organic material to be protected and on its use.

Advantageously, such a compound of general formula I can be employed in a proportion of 0.1 to 20 g/m², in particular of 1 to 10 g/m², indeed even between 4 and 5 g/m², of the material.

The pyrene derivatives under consideration according to the invention can, on the other hand, be combined in these materials with other compounds, such as:
a) other UV screening agents and light stabilizers, such as benzotriazoles, benzophenones, benzoic acid esters, it being possible for all of these compounds to be substituted or unsubstituted, acrylates, nickel compounds, sterically hindered amines, oxamides or also 2-(2-hydroxyphenyl)-1,3,5-triazines, or also the hexyl ester of 2-(4-diethylamino-2-hydroxybenzoyl)benzoic acid,
b) inorganic UV screening agents, such as TiO₂, ZnO or CeO₂,
c) alloys or mixtures based on CeO₂,
d) additives, such as antioxidants or free radical deactivators,
e) stabilizing agents,
f) organic or inorganic coloring agents,
g) nucleating agents,
h) inorganic or organic fillers,
i) other additives, such as plasticizers, lubricants, emulsifiers, pigments, rheological additives, catalysts or antistatic agents.

The invention also relates to a process for the stabilization of a material, in particular an organic material and especially as defined above, with regard to UV decomposition, comprising the addition, to this material or to a precursor of this material, of at least one pyrene derivative under consideration according to the invention as agent which absorbs ultraviolet radiation.

More particularly, it is an organic material and more particularly a material of polymeric nature.

As emerges from the following, the derivative can be employed directly on the material to be protected from solar irradiation but also on a precursor of this material, that is to say with one of the starting materials necessary for the preparation of the final material, for example a monomer for the preparation of a polymer, or a polymer for the preparation of a polymeric material.

The incorporation in organic polymers, for example synthetic organic polymers and in particular thermoplastic polymers, can be carried out by addition of the pyrene derivative(s) under consideration according to the invention and of any other additive by methods conventional in this field.

Thus, during incorporation in a polymeric material, the pyrene derivatives under consideration according to the invention can be incorporated, if appropriate, in the solid state or in the solute state, in particular in aqueous solution, either directly in the polymer, on the one hand, or before or during the polymerization of the corresponding monomer, or before the formation of a network, on the other hand.

It is also possible to envisage the incorporation of the pyrene derivatives under consideration according to the invention in polymers by the melt route.

The polymers stabilized according to this method can be transformed into articles, such as fibers, films, sheets, packagings, pipes and other profile elements, by conventional methods, such as thermal molding, extrusion or injection molding.

Likewise, the use of the pyrene derivatives under consideration according to the invention as agents which absorb ultraviolet radiation, in a material dedicated to forming a coating, for example a paint, is particularly advantageous.

In the case of a fluid material, such as a paint, the pyrene derivatives under consideration according to the invention can be directly introduced into the material, either in the solid state or in the form of an aqueous or organic solution, depending on the nature of the material.

The fluid materials thus treated according to the invention can be applied in the form of a coating at the surface of any substrate, for example made of metal, wood, plastic or ceramic.

The pyrene derivatives under consideration according to the invention are also suitable for use in a process for the photochemical stabilization of uncolored, colored or printed fibrous materials, such as, for example, silk, leather, wool, polyamides, polyesters, polyaramids, polyacrylics or polyurethanes, and more particularly fibrous materials comprising cellulose, such as cotton, flax or jute, and also viscose fibers and regenerated cellulose.

The pyrene derivatives under consideration according to the invention can advantageously be employed in contents ranging from 0.1 to 20 g/m², in particular from 1 to 10 g/m² by weight, indeed even between 4 and 5 g/m² by weight, of the material.

Thus, the invention also relates to a process for increasing the sun protection factor of textile fibers which comprises bringing said fibers into contact with at least one derivative in accordance with the invention under conditions propitious to the immobilization of said derivative on said fibers.

This immobilization or also fixing can, for example, be carried out according to the “padding” technique. This technique consists in producing an aqueous solution comprising the UV screening agent with optionally dispersing agents, an adjusted pH, binders, and the like. The textile to be treated is dipped therein for impregnation and then run out.

Another technique suitable for the fixing is that of coating, which consists in coating the textile to be treated with a viscous aqueous solution comprising the screening agent, a binder, optionally dispersing agents, an adjusted pH, thickeners, and the like.

The use of these two techniques also comes within the competence of a person skilled in the art.

The value of the sun protection factor (SPF) indicates the ability of a product to screen out or block the rays from the sun.

The textile material to be protected is preferably a dyed textile material.

If the pyrene derivatives under consideration according to the invention are added during the dyeing stage, they can be added so that the textile material is first treated with said derivatives and then subsequently with the dye or, preferably, so that the material is treated simultaneously with said derivatives and the dye.

For the production of inks, the pyrene derivatives under consideration according to the invention can be mixed with ink pastes.

The pyrene derivatives under consideration according to the invention are also suitable as photoprotective agents, generally in an encapsulated form, in cosmetic preparations.

The following examples and figures are presented by way of illustration and without implied limitation of the field of the invention.

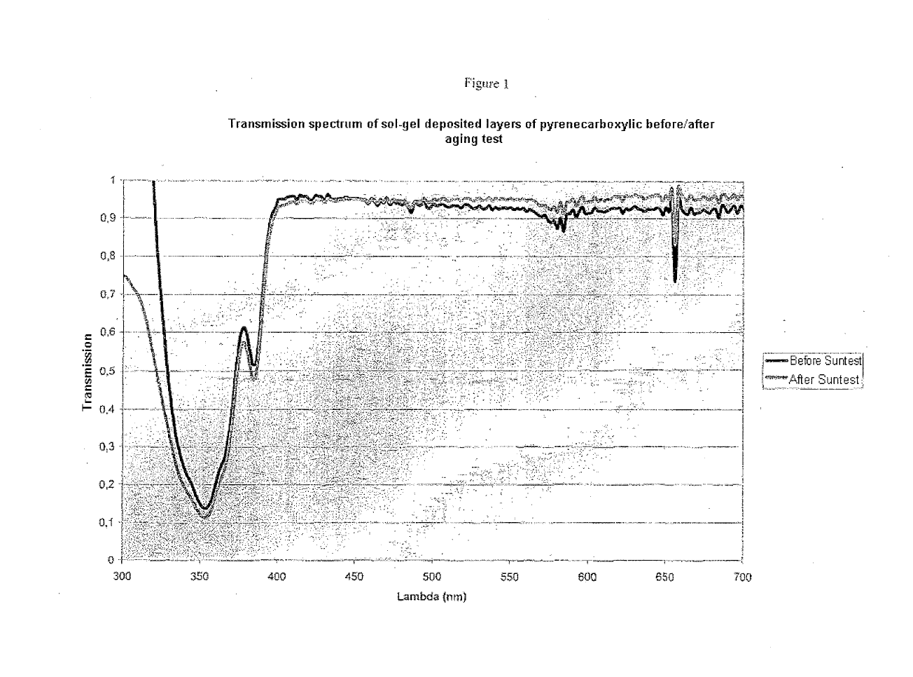

FIG. 1: UV transmission spectra of a silica sol-gel deposited layer in which pyrene-1-carboxylic is incorporated before/after exposure.

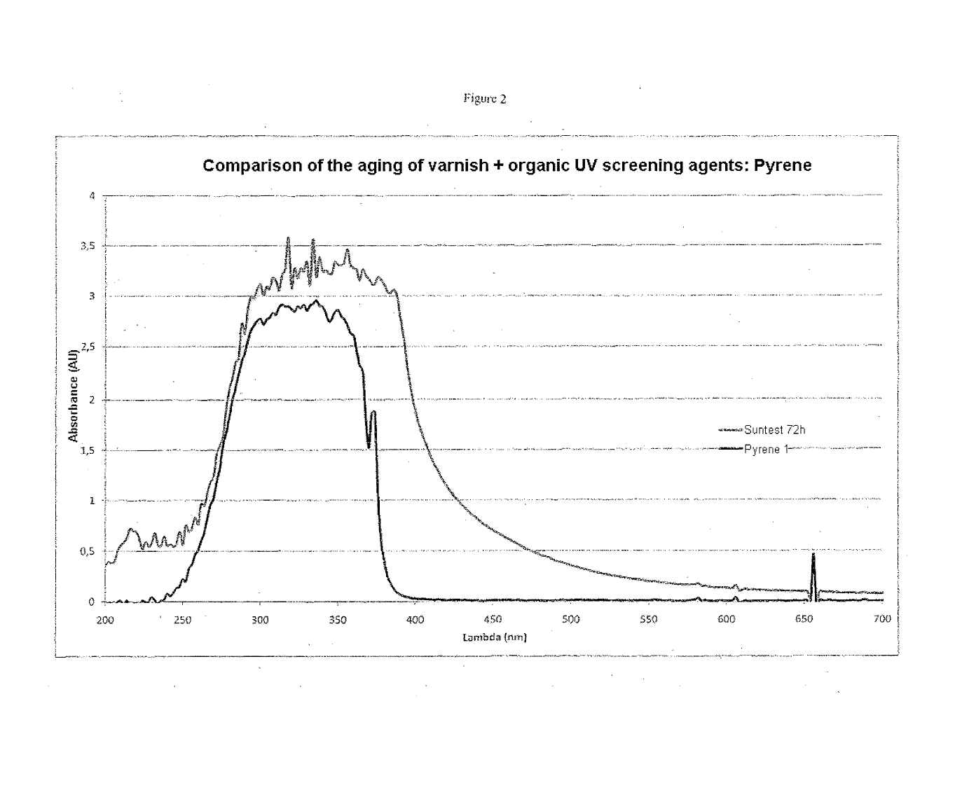

FIG. 2: UV transmission spectra of a polyurethane varnish in which nonfunctionalized pyrene is incorporated, before/after exposure.

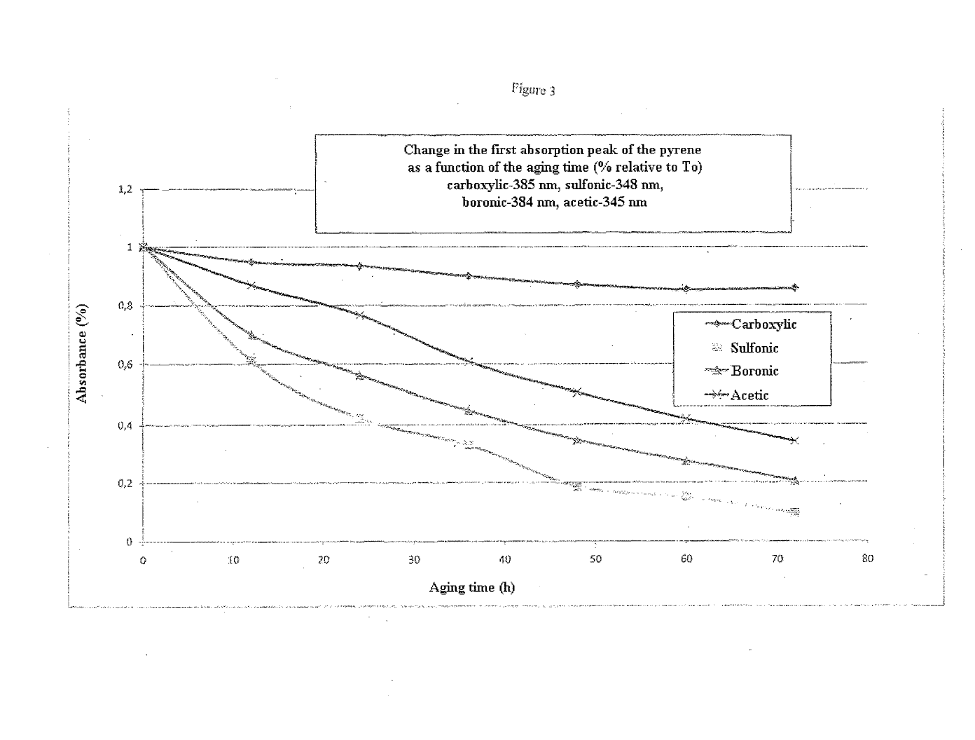

FIG. 3: Change in the absorption peak of pyrene derivatives as a function of time.

### EXAMPLE 1

### Silica Sol-Gel Deposited Layer Comprising Pyrene-1-Carboxylic

A silica sol-gel solution is formed by the hydrolysis of a silicon alkoxide (tetraethoxysilane, CAS No. 78-10-4) in the presence of ethanol and hydrochloric acid.

A 0.5 mg/ml aqueous pyrene-1-carboxylic solution is formed with a molar equivalent of sodium hydroxide.

One volume of the pyrene-1-carboxylic solution is mixed with an equivalent volume of the sol-gel solution: the mixture is deposited by “knife coating” on a microscope slide transparent to UV-A radiation.

After drying in ambient air, this slide is subjected to an accelerated aging test in a Suntest CPS chamber from Atlas.

The aging conditions are as follows: irradiance at 620 W/m², xenon arc lamp equipped with a “sheet glass” filter which cuts off the UV radiation below 310 nm, exposure time 24 h.

FIG. 1 reports the UV transmission spectra of the silica sol-gel deposited layer in which the pyrene-1-carboxylic is incorporated, before/after exposure.

Comparing these spectra shows that the UV/visible transmission properties of the coating are retained. The “light” stability of the pyrene-1-carboxylic compound is thus confirmed.

### EXAMPLE 2

### Use of Pyrene-1-Carboxylic as UV Protector on a Textile Substrate

A sol-gel deposited layer is produced on a glass slide under the same conditions as example 1 above, with a starting 5 mg/ml solution of pyrene-1-carboxylic.

This sample is used as filter affixed to a colored textile.

A glass slide not treated with this deposited layer is also affixed to another sample of the same colored textile for the purposes of reference sample.

The two samples are exposed to an accelerated aging test in a Suntest CPS chamber from Atlas. The aging conditions are as follows and in accordance with the standard NF EN ISO 105-B2: irradiance at 550 W/m², xenon arc lamp equipped with a “sheet glass” filter which cuts off the UV radiation below 310 nm, exposure time 72 h.

On conclusion of the test, it is noted that:
the sol-gel deposited layer comprising the pyrene-1-carboxylic has not changed in color: this confirms, at a greater exposure than example 1, the stability of pyrene-1-carboxylic.
the reference sample obtains a degradation grade on the scale of the blues of 1 (on a scale comprising 8 levels, from the most degraded, 1, to the least degraded, 8), whereas the sample treated with the coating obtains a grade of 4-5.

The effectiveness in terms of light protection of the deposited layer produced is thus indeed confirmed.

### EXAMPLE 3, COMPARATIVE

### Polyurethane Varnish Deposited Layer Comprising a Pyrene not in Accordance with the Invention

The object of this example is to demonstrate that a pyrene not having the characteristics of the invention does not have light stability.

A curing agent is added to a solution of polyurethane (70% by weight) in a xylene/toluene mixture.

A molecule of nonfunctionalized pyrene (CAS No. 129000) is added in a proportion of 50 mg of pyrene per gram of polyurethane solution.

The mixture is deposited by “knife coating” on a glass slide transparent to UV-A radiation.

After drying in ambient air, this slide is subjected to an accelerated aging test in a Suntest CPS chamber from Atlas. The aging conditions are as follows: irradiance at 550 W/m², xenon arc lamp equipped with a “sheet glass” filter which cuts off the UV radiation below 310 nm, exposure time 72 h.

Comparing the absorption spectra of the slide before/after exposure, which appear in FIG. 2, shows that the UV/vis transmission properties of the coating are very significantly degraded. The pyrene not in accordance with the invention is obviously not stable to light.

### EXAMPLE 4, COMPARATIVE

The object of this example is to demonstrate the superior stability toward UV radiation of pyrene-1-carboxylic in comparison with pyrene derivatives not in accordance with the invention.

A silica sol-gel solution as defined in example 1 is prepared.

At the same time, four aqueous solutions respectively comprising pyrenecarboxylic, pyrenesulfonic, pyreneboronic and pyreneacetic, at 0.5 mg/ml, with one molar equivalent of sodium hydroxide, are prepared.

A volume of each aqueous solution thus obtained is mixed with an equivalent volume of the sol-gel solution: each mixture obtained is subsequently deposited by “knife coating” on a microscope slide transparent to UV-A radiation.

After drying in ambient air, these slides are subjected to an accelerated aging test in a Suntest CPS chamber from Atlas.

The aging conditions are as follows: irradiance at 620 W/m², xenon arc lamp equipped with a “sheet glass” filter which cuts off the UV radiation below 310 nm, exposure time 24 h. The temperature for regulating the black body is 55° C.

FIG. 3 reports the absorption spectra of the different pyrene derivatives described above as a function of time.

Comparing these spectra shows that the best stability over time is represented in a significant way by the pyrenecarboxylic in accordance with the invention.

1.-12. (canceled)

13. A process for the stabilization of an organic or inorganic material with regard to UV degradation, comprising the addition, to this material or to a precursor of this material, of at least one pyrene derivative represented by the general formula (I): 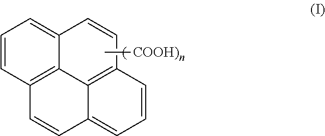
wherein n represents an integer from 1 to 4, or one of its salts, as agent which absorbs ultraviolet radiation.

14. The process of claim 13, wherein n is less than or equal to 2.

15. The process of claim 13, wherein said pyrene derivative is of formula: 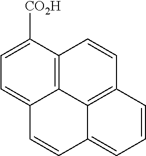 [SMILES: O=C(O)c1ccc2ccc3cccc4ccc1c2c34]
or one of its inorganic salts.

16. The process of claim 13, wherein the salts are of alkaline type.

17. The process of claim 16, wherein the salts are sodium or potassium salts.

18. The process of claim 13, wherein said derivative exhibits several very strong absorption peaks between 290 nm and 360 nm.

19. The process of claim 13, wherein said derivative is employed in a proportion of 0.1 to 20 g/m² of the material.

20. The process of claim 19, wherein said derivative is employed in a proportion of 1 to 10 g/m² of the material.

21. The process of claim 20, wherein said derivative is employed in a proportion of between 4 and 5 g/m² of the material.

22. An organic or inorganic material comprising, as agent which absorbs ultraviolet radiation, at least one derivative as defined in claim 1.

23. The material of claim 22, wherein said derivative is employed in a proportion of 0.1 to 20 g/m² of the material.

24. The material of claim 23, wherein said derivative is employed in a proportion of 1 to 10 g/m² of the material.

25. The material of claim 24, wherein said derivative is employed in a proportion of between 4 and 5 g/m² of the material.

26. The material of claim 22, further comprising a coloring agent.

27. The material of claim 22, further defined as a polymeric material.

28. The material of claim 22, further defined as a textile.

29. A process for increasing the sun protection factor of textile fibers, comprising bringing said fibers into contact with at least one derivative as defined in claim 1, under conditions propitious to the immobilization of said derivative on said fibers.
